(19) United States
(12) Patent Application Publication
(10) Pub. No.: US 2009/0157849 A1
(43) Pub. Date: Jun. 18, 2009

(54) SYSTEMS AND METHODS FOR PHOTO MANAGEMENT

(76) Inventor: SEAMUS MCDONALD, (US)

Correspondence Address: Joseph Curtis Edmondson, 15490 NW Oak Hills Dr, Beaverton, OR, 97006, US

(21) Appl. No.: 12/244,680

(22) Filed: Oct. 2, 2008

Related U.S. Application Data
(60) Provisional application No. 60/977,028, filed on Oct. 2, 2007.

(51) Int. Cl. G06F 15/16

(52) U.S. Cl. 709/219

(57) ABSTRACT

A photo management system is described herein consisting of a server, a mobile device, and the internet; furthermore systems and software located on the server and the mobile device provide connectivity and functionality for the exchange of photos.

### RELATED APPLICATIONS

This application claims priority to U.S. Provisional Patent Application 60/977,028 filed on Oct. 2, 2007.

### NOTICE OF COPYRIGHTS AND TRADE DRESS

A portion of the disclosure of this patent document contains material, which is subject to copyright protection. This patent document may show and/or describe matter, which is or may become trade dress of the owner. The copyright and trade dress owner has no objection to the facsimile reproduction by anyone of the patent disclosure, as it appears in the Patent and Trademark Office patent files or records, but otherwise reserves all copyright and trade dress rights whatsoever.

### BACKGROUND

This disclosure relates to a system and process for managing photos and specifically to an online system for use by print media and newspapers to directly link a photo of an item for sale with a classified advertisement.

### SUMMARY

These and other embodiments are described in more detail in the following detailed descriptions and the figures.

The foregoing is not intended to be an exhaustive list of embodiments and features of the inventive subject matter. Persons skilled in the art are capable of appreciating other embodiments and features from the following detailed description in conjunction with the drawings.

### DESCRIPTION OF THE DRAWINGS

FIG. 1 is a block diagram of a system for photo management system.

FIG. 2 is a flow chart of a process for managing photos.

FIG. 3 is a flow chart of a process for accessing a photo management system by a registered user.

FIG. 4 is a flow chart of a process for accessing a photo management system by an unregistered user.

FIG. 5 is a flow chart of a process for accessing a photo management system by a registered advert user.

FIG. 6 is a flow chart of a process for accessing a photo management system by an unregistered advert user.

FIG. 7 is a flow chart of a process for accessing a photo management system by a print media business.

### DETAILED DESCRIPTION

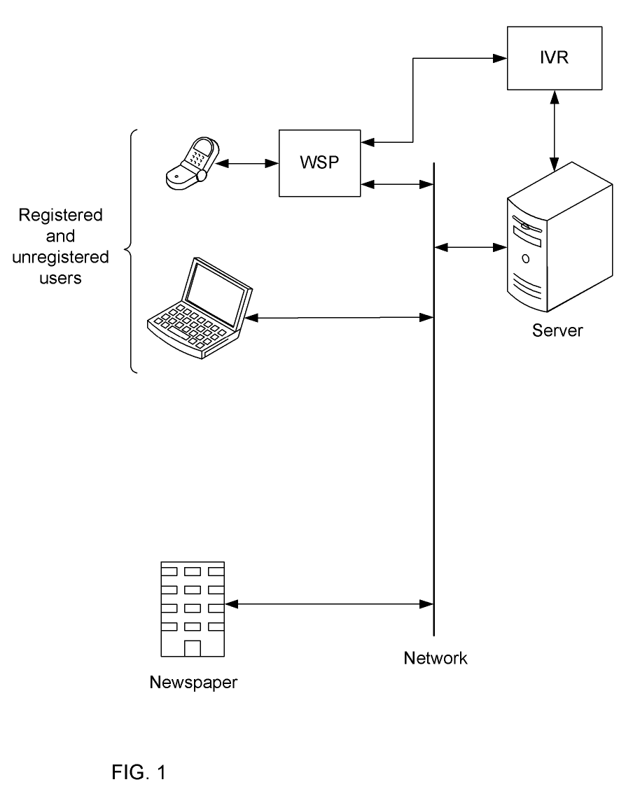

Representative embodiments according to the inventive subject matter are shown in FIGS. 1-7, wherein the same or generally similar features share common reference numerals.

FIG. 1 is a block diagram of a photo management system which may include at least one server for storing and managing photos submitted by users. Although FIG. 1 shows a single server, the functions of the photo management system may be partitioned between a plurality of servers, some of which may be dedicated to specific functions, such as a Web server or a file server. In this context, a “server” is any computing device capable of performing all or part of the functions of the photo management system.

The server may be connected to at least one network, which may be the Internet. The server may be connected to other networks, such as a local area network, storage network, or wide area network, in addition to the Internet. Registered and unregistered users may interact with the server by means of network-connected devices or by means of mobile communication devices via an intermediary wireless service provider (WSP). Although FIG. 1 shows a laptop computer as an example of a network-connected device, any network-connected device may be used including personal computers, tablet computers, personal digital assistants, and any other network-connected devices. Similarly, although FIG. 1 shows a cellular phone as an example of a mobile communication device, other mobile devices, such as wireless email appliances and two-way messaging pagers, may be used. The server may interact with newspaper or other print media users by means of the Internet or other network.

The server may be connected with, or may include, an interactive voice response (IVR) system to allow interaction with users who are unable or unwilling to use text messaging or other simple message service (SMS) messages from a mobile communication device.

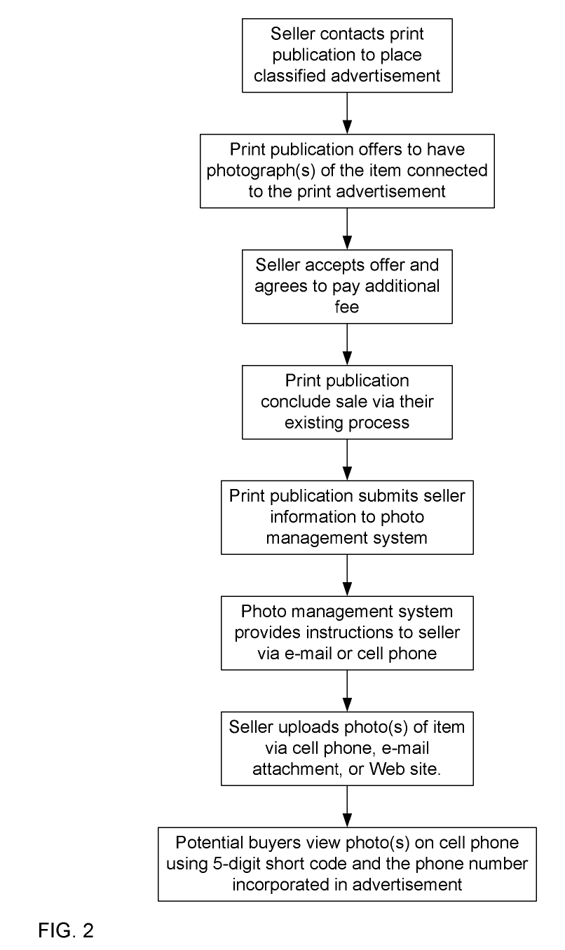

FIG. 2 is a flow chart of a process for managing photos. This process may be consistent with the photo management system of FIG. 1.

The process for managing photos may begin when a seller, having an item for sale, contacts a newspaper or other print publication to place a classified advertisement. The print publication may offer the seller the opportunity to have one or more photographs of the item connected to the print advertisement. The print publication may explain that, for a small additional fee, a photo of the item may be sent to prospective buyers via the buyer's mobile communication device or may be accessed via a website.

If the customer accepts the additional service, the photo management service fee may be included in the total advertisement fee and billed by the print publication through their traditional order processing methods. The print publication may conclude the sale using their existing processes and may inform the seller that instruction for uploading the photo(s) of the item will be provided by email.

The print publication may then establish a discrete code for the advertisement and submits information on the seller and the advertisement to the photo management system. Conveniently, the seller's phone number may be used as the discrete code.

Upon receipt of the information from the print publication, the photo management system may establish an account for the seller as a registered advertising user. The photo management system may then send an email message or a text message to the registered advertising user (the seller) including instructions for submitting photos.

The registered advertising user may then upload one or more photos to the photo management system. Photos may be submitted directly from the registered advertising user's cell phone, by e-mail attachment, or via the photo management system Web site.

Potential buyers may then view photos using their cell phones. For example, the potential buyers may dial a five-digit short code to access the photo management system and then enter the phone number printed in a classified advertisement to access the appropriate photos.

The photo management system may not be limited to receiving and managing only photos specifically linked to advertisements. For example, the photo management system may be used to manage photos for previously registered users who do not have current print media advertisements.

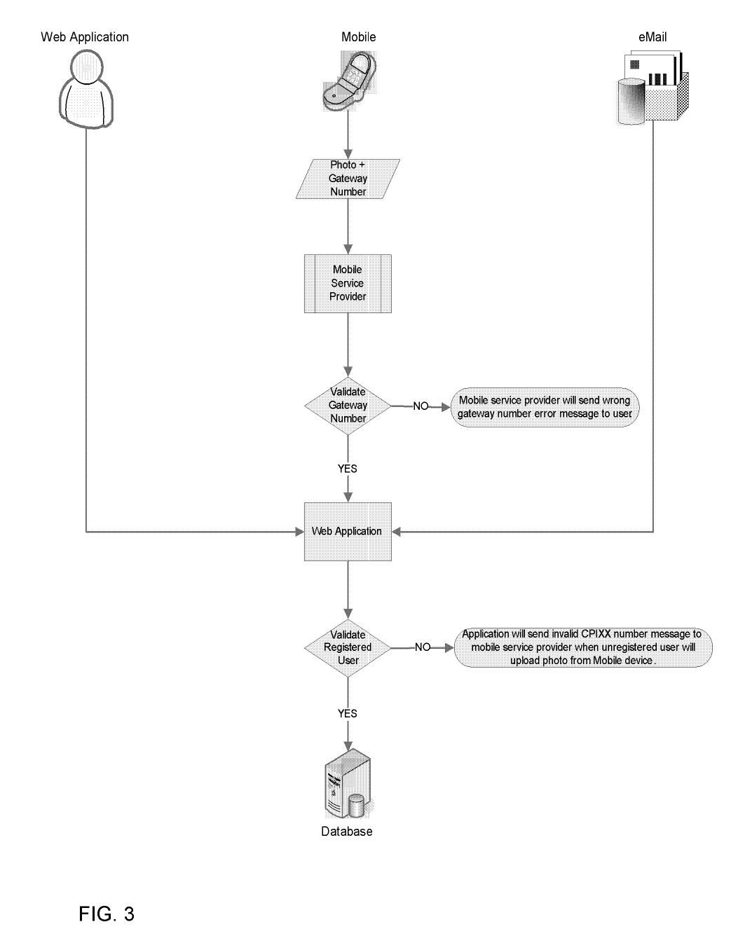

FIG. 3 is a flow chart of a process that may be used by a normal registered user, herein termed a “CPIXX user”, to access the photo management system. The CPIXX user may add multiple photos to a profile associated with the registered user (herein termed a “CPIXX profile”) and stored on the server. A CPIXX user may add photos to their CPIXX profile by means of text messages from a mobile communication device, by means of a network-connected device, or by means of e-mail.

A CPIXX user may take a picture from a mobile device and sent it to their CPIXX profile using a gateway number provided by their mobile service provider. The Mobile service provider may receive the photo and the gateway number sent by user. The Mobile service provider may authenticate the gateway number. If the gateway number is correct, the service provider may pass the photo and the user's mobile number to the photo management system with a parameter which contains type of data. (0=Photo and 1=Text message). If the gateway number is incorrect, the mobile service provider may send an “incorrect gateway number” message to the CPIXX user.

When the photo management system receives the data from the mobile service provider with the parameter, the photo management system may authenticate the CPIXX user by his/her mobile number or some other method. If the CPIXX user is registered, the photo management system may store the photo into the CPIXX user's profile in the database. If the CPIXX user is unregistered, the photo management system may send an “invalid user” message to mobile service provider and mobile service provider may forward the message to mobile user.

Alternatively, a CPIXX user may upload photos to his/her CPIXX profile using a network-connected device. The CPIXX user may first login to the photo management system by passing credentials which may include a user name and a password. The photo management system may then authentic the credentials entered by user. If the entered user name and password are valid, the CPIXX user may be enabled to add new photos to their CPIXX profile.

Additionally, a CPIXX user may also upload photos to their CPIXX profile using e-Mail. The CPIXX user may attach one or more photos to an email, include the CPIXX number as the email subject and send the email message to the photo management system. The photo management system may parse the received email message to retrieve the CPIXX number and the attached photos. The photo management system may authenticate the CPIXX number. If the CPIXX number is valid, the photo management system may add the attached photos to the CPIXX user's profile.

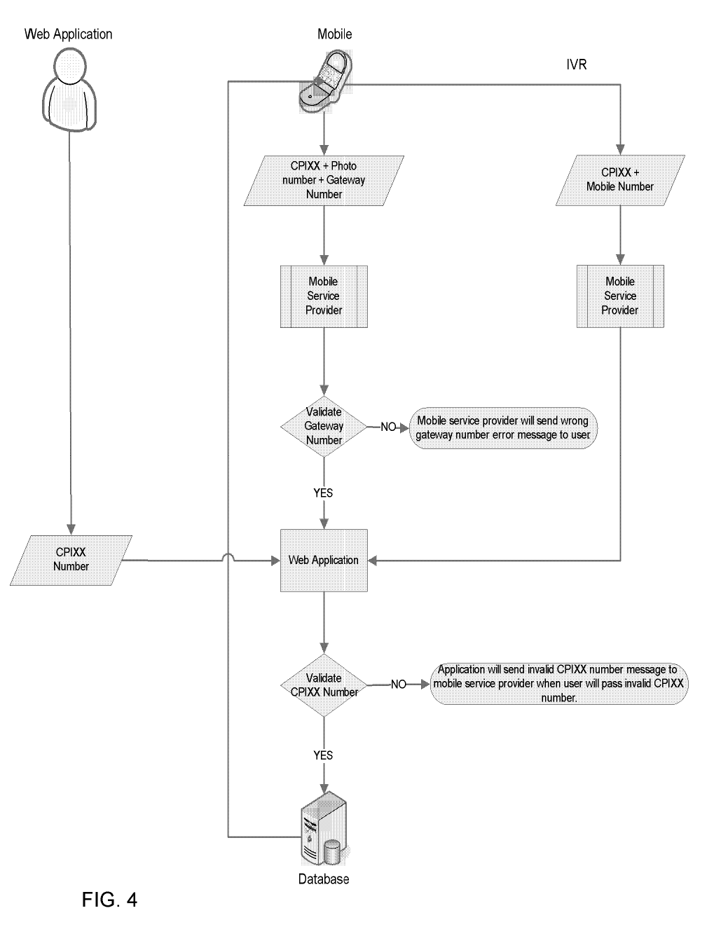

FIG. 4 shows a flow chart of the process that may be used by an unregistered user to access the photo management system. An unregistered user may view permitted photos uploaded to the photo management system by registered CPIXX users. An unregistered user can view a CPIXX user's photos using text messages from a mobile communication device, using a computer connected to the network, or using an interactive voice response system (IVR).

An unregistered user may pass a CPIXX number and a gateway number as SMS messages to their mobile service provider. The unregistered user may also pass a photo number along with the CPIXX number and the gateway number to view a selected photo instead of all photos. When the mobile service provider receives the CPIXX number, the gateway number and the optional photo number sent by the unregistered user, the mobile service provider may authenticate the gateway number. If the gateway number is correct, the mobile service provider may pass the CPIXX number, the gateway number and the optional photo number to the photo management system. If the gateway number is incorrect, the mobile service provider may send an “incorrect gateway number” message to the unregistered user.

When the photo management system receives data from mobile service provider, the photo management system may check availability of the designated CPIXX user. If the CPIXX user is registered, the photo management system may fetch the selected photo if a photo number was provided, or all permitted photos in the CPIXX user's profile from database and send them to the unregistered user's mobile device. If the provided CPIXX number does not correspond to a registered user, the photo management system may send an “invalid user” message to the mobile service provider and the mobile service provider may forward the message to mobile user.

Unregistered users who are unable or unwilling to send SMS messages, may access photos by calling a dedicated phone number and using an IVR system to enter the CPIXX number and optional photo number. After the validity of the CPIXX number is checked, the photos may be sent to the unregistered user's mobile device as previously described.

Alternatively, an unregistered user may view a registered CPIXX user's photos from a device connected to the network by accessing the photo management system web site and entering a CPIXX number. The photo management system may check if the CPIXX number is valid or not. If CPIXX number is valid, the photo management system will show photos to the unregistered user.

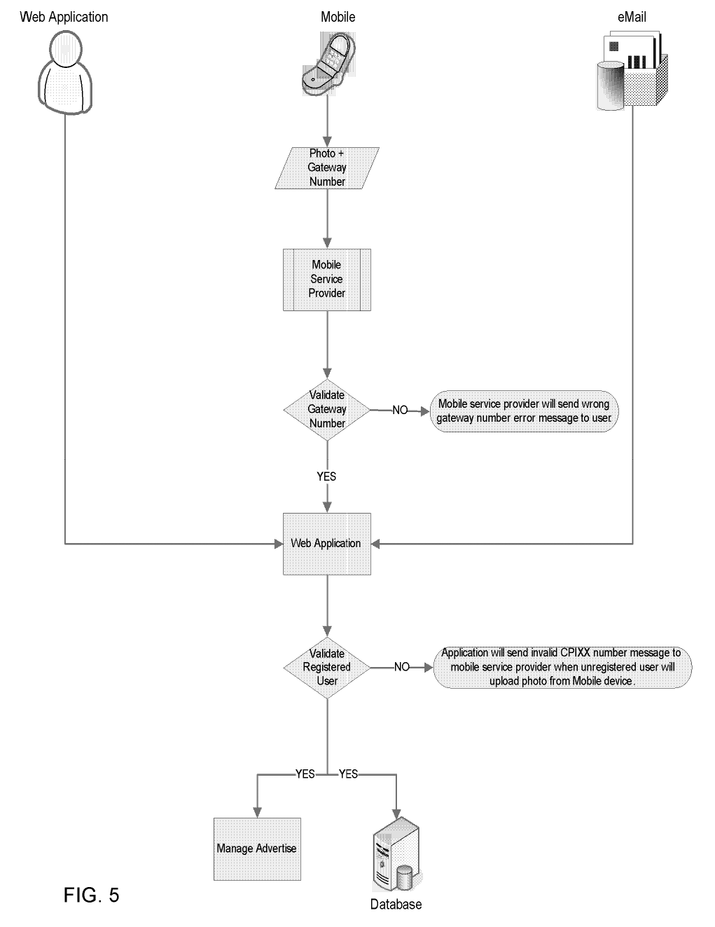

FIG. 5 shows a flow chart of the process that may be used by an registered advertising user to access the photo management system. A registered advertising user is a registered user who has purchased an advertising package from a newspaper or other print media. A registered advertising user can upload unlimited photos to his/her CPIXX profile, but can connect photos to advertisements only as defined in the advertising package. A registered advertising user may access the photo management system and upload photos using three techniques that are essentially the same as those previously described in conjunction with FIG. 3. Once photos are uploaded, the registered advertising user can connect specific photos to advertisements as permitted by the advertising package.

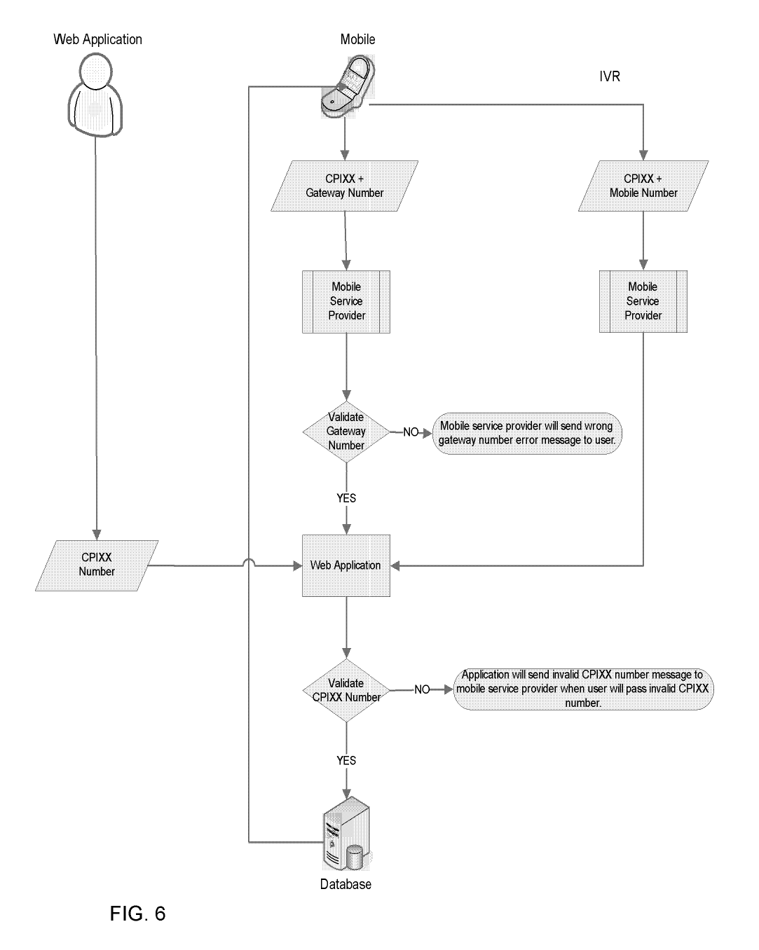

FIG. 6 shows a flow chart of a process that may be used by an unregistered advertising viewer to access the photo management system. The process may be essentially the same as that described in conjunction with FIG. 4, except that the unregistered advertising viewer may obtain a CPIXX number from a printed classified advertisement, and the CPIXX number may be directed to a specific advertisement, rather than to a registered user.

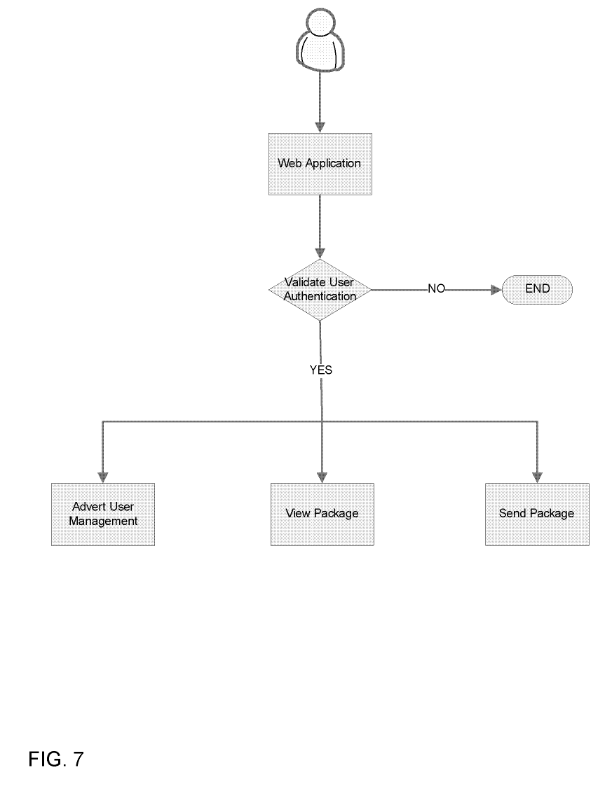

FIG. 7 shows a flow chart of a process that may be used by a newspaper user to access the photo management system. In this context, “newspaper user” is intended to encompass any form of print media user. A newspaper user may access photo management system by means of a network-connected device running a suitable Web application.

The newspaper user may first login to the photo management system by passing credentials such as a user name and a password. The photo management system may authenticate the credentials entered by the newspaper user. If the credentials are valid, the newspaper user may be allowed to access several program modules to manage advertising users and advertising packages.

Persons skilled in the art will recognize that many modifications and variations are possible in the details, materials, and arrangements of the parts and actions which have been described and illustrated in order to explain the nature of the inventive subject matter, and that such modifications and variations do not depart from the spirit and scope of the teachings and claims contained therein.

All patent and non-patent literature cited herein is hereby incorporated by references in its entirety for all purposes.

While the inventor understands that claims are not a necessary component of a provisional patent application, and therefore has not included detailed claims, the inventor reserves the right to claim, without limitation, at least the following subject matter.

1. I claim a system for photo management wherein said system comprises a server, a mobile phone device, and a photo management device, wherein said server exchanges a multiplicity of photos between the photo management device and the mobile phone device.
